(19) United States
(12) Patent Application Publication
(10) Pub. No.: US 2004/0080487 A1
(43) Pub. Date: Apr. 29, 2004

(54) Electronic device having keyboard for thumb typing

(76) Inventors: Jason T. Griffin, Waterloo (CA); Norman M. Ladouceur, Waterloo (CA)

Correspondence Address: David B. Cochran, Esq., Jones, Day, Reavis & Pogue, North Point, 901 Lakeside Ave, Cleveland, OH, 44114, US

(21) Appl. No.: 10/282,776

(22) Filed: Oct. 29, 2002

(51) Int. Cl. G09G 5/00

(52) U.S. Cl. 345/156

(57) ABSTRACT

An electronic device that includes an electronic display screen having a first display area for displaying a first set of a plurality of selectable symbols and a second display area for displaying a second set of a plurality of selectable symbols, a first user input device for selecting symbols from the first set, the first user input device generating a first selection signal in response to force applied thereto, and a second user input device for selecting symbols from the second set, the second user input device generating a second selection signal in response to force applied thereto. A processor is connected to the display screen and the first and second input devices for causing one of the symbols in the first set to be visually highlighted in the first display area in response to the first selection signal and one of the symbols in the second set to be visually highlighted in the second display area in response to the second selection signal.

### FIELD OF THE INVENTION

The present invention relates to character input methods and keyboards for use in electronic devices.

### BACKGROUND OF THE INVENTION

In order to reduce space requirements and mechanical complexity, keyboards and keypads are often configured so that more than one input value is mapped to a particular key. Particularly, in the case of a portable electronic device, the user input mechanism must be small enough so that the device can be worn on the body of a user. Some existing input systems for small handheld devices incorporate virtual keyboards or stylus-based input systems, and some input systems use standard 12-key telephone keypads. Entering text using such input systems requires the user to input data in an unfamiliar manner. Other kinds of keyboards follow the standard Dvorak or, more commonly, the QWERTY keyboard models and are used in portable handheld devices such as the RIM 950 Wireless Handheld™. This kind of keyboard when adapted to handheld devices uses a plurality of small individual keys optimized for operation with the thumbs of the user. However, such a keyboard has considerably more keys than a telephone style keypad and the larger number of individual keys requires more space on a printed circuit board (PCB) than a telephone style keypad. Each key requires its own footprint and switch on the PCB. Because of the relatively small size of such handheld devices, PCB space is limited and a QWERTY or Dvorak type keyboard takes up valuable real estate on the PCB.

Such a keyboard also requires a great deal of tooling in order to accommodate the large number of individual keys in the housing of a handheld device. This tooling adds to manufacturing costs.

Additionally, the keys in such keyboards are typically mapped to specific alphanumeric values, and remapping of the keys for non-QWERTY or non Dvorak configurations, for example a configuration that allows a user in input characters from other languages such as Chinese, results in an input system that is cumbersome to use.

Therefore, an input device having a reduced number of keys necessary for a QWERTY or Dvorak type keyboard layout is desirable. An input device that can also allow alternative character sets to be input with a reduced number of keys is also desirable.

### SUMMARY OF THE INVENTION

Aspects of the invention relate to a portable electronic device that includes a screen on which a plurality of selectable characters are displayed and thumb actuated input devices for selecting the displayed characters as inputs.

According to one aspect of the invention, there is provided an electronic device that includes an electronic display screen having a first display area for displaying a first set of a plurality of selectable symbols and a second display area for displaying a second set of a plurality of selectable symbols, a first user input device for selecting symbols from the first set, the first user input device generating a first selection signal in response to force applied thereto, and a second user input device for selecting symbols from the second set, the second user input device generating a second selection signal in response to force applied thereto. A processor is connected to the display screen and the first and second input devices for causing one of the symbols in the first set to be visually highlighted in the first display area in response to the first selection signal and one of the symbols in the second set to be visually highlighted in the second display area in response to the second selection signal. Preferably, the first user input device and the second user input device each sense in at least two dimensions a direction of a force applied thereto and said first selection signal and said second selection signal each include directional force information corresponding to the force direction sensed by the first and second user input devices, respectively. The first symbol set may include the alphabetic characters associated with left hand typing in a conventional QWERTY layout and the second set may include the alphabetic characters associated with right hand typing in a conventional QWERTY layout.

According to another aspect of the invention, there is provided method of selecting characters for input to an electronic device. The method includes steps of: (a) displaying on an electronic display screen a first set of selectable characters in a first area of the display screen; (b) displaying on the electronic display screen a second set of selectable characters in a second area of the display screen; (c) visually highlighting in the first area a selected character in the first set when a directional signal is received from a first input device that corresponds to a physical display location of the selected character; and (d) visually highlighting in the second area a selected character in the second set when a directional signal is received from a second input device that corresponds to a physical display location of the selected character in the second set.

According to a further aspect of the invention, there is provided an electronic device that includes an electronic display screen having a first selectable text display area for displaying a plurality of selectable alphabetic characters in a two dimensional array, and a working text display area for displaying characters selected as input from the characters displayed in the first selectable text display area. A first user input device is provided for selecting characters in the selectable text display area, the first user input device responsive to force applied thereto in a plurality of directions to generate a first selection signal that indicates a direction of a force applied thereto relative to a biased resting position of the first user input device. A processor is operatively connected to the display screen and connected to receive the first selection signal from the first user input device. The processor maps the first selection signal associated with the resting position of the first user input device to a predetermined home character located in a central position in the two dimensional array of selectable characters and maps the first selection signal to the selectable characters based on their display locations relative to the predetermined character. The processor also signals the display screen to visually highlight in the first selectable text area a selected character in response to the first selection signal according to the mapping, and signals the display screen to display a selected character in the working text display area as an input character upon receiving a further user input when the selected character is visually highlighted in the first selectable text area. Preferably, the display screen includes a second selectable text display area displaying a further plurality of selectable alphabetic characters in a further two dimensional array, and the device includes a second user input device for selecting characters in the second selectable text display area.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

Embodiments of the present invention will now be described, by way of example only, with reference to the attached Figures, wherein:

FIG. 1 is a block diagram of a mobile communication device to which the present invention may be applied;

FIG. 2 is a plan view of a mobile communication device in accordance with one embodiment of the invention;

FIG. 3 is a simplified perspective view showing a thumb input device of the mobile communication device of FIG. 2;

FIG. 4 is a general block diagram of the major software subsystems implemented on a microprocessor of the mobile communication device of FIG. 2;

FIG. 5 is a further plan view of the mobile communication device of FIG. 2, showing a different screen display;

FIG. 6 is a plan view of a mobile communications device according to a further embodiment of the invention;

FIG. 7 is a plan view of a mobile communications device according to another embodiment of the invention;

FIG. 8 is a plan view of a mobile communications device according to still another embodiment of the invention;

FIG. 9 is a diagrammatic view of an alternative thumb actuated input device for the mobile communications device of FIG. 8;

FIG. 10 is a further plan view of the device of FIG. 2, showing yet another screen display; and

FIG. 11 is a diagrammatic view of a character input system according to a further embodiment of the invention.

### DETAILED DESCRIPTION

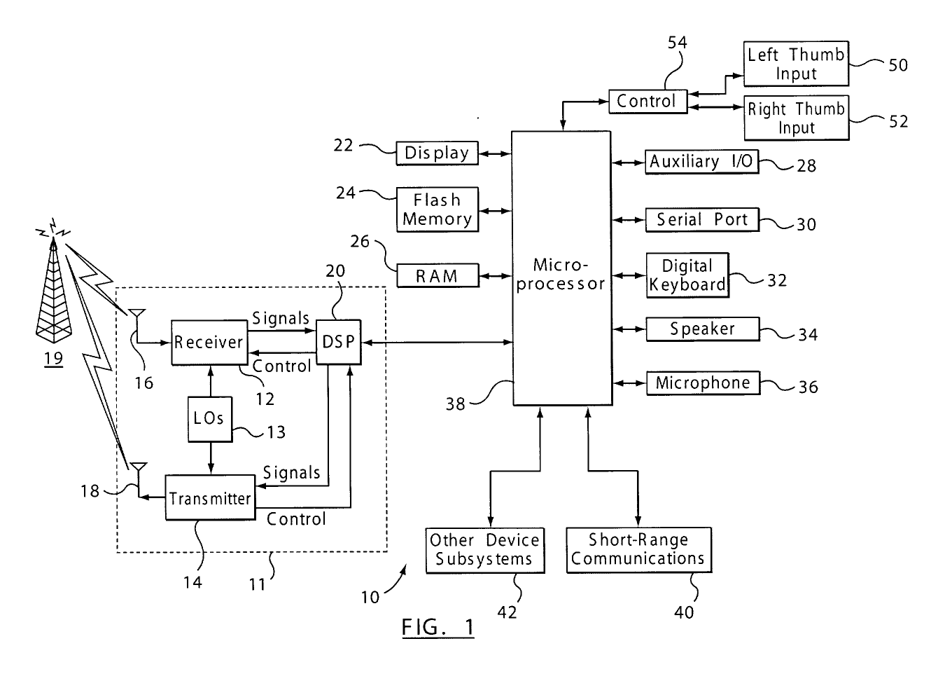

Referring now to the drawings, FIG. 1 is a block diagram of a mobile communication device 10 in which the present invention may be implemented. The mobile communication device 10 is a two-way communication device having at least data and preferably also voice communication capabilities. The device preferably has the capability to communicate with other computer systems on a network, for example the Internet or an intranet. Depending on the functionality provided by the device, the device may be referred to as a data messaging device, a two-way pager, a cellular telephone with data messaging capabilities, a wireless Internet appliance or a data communication device (with or without telephony capabilities).

Where the device 10 is enabled for two-way communications, the device will incorporate a communication subsystem 11, including a receiver 12, a transmitter 14, and associated components such as one or more, preferably embedded or internal, antenna elements 16 and 18, local oscillators (LOs) 13, and a processing module such as a digital signal processor (DSP) 20. As will be apparent to those skilled in the field of communications, the particular design of the communication subsystem 11 will be dependent upon the communication network in which the device is intended to operate.

Signals received by the antenna 16 through a communication network 19 are input to the receiver 12, which may perform such common receiver functions as signal amplification, frequency down conversion, filtering, channel selection and the like, and in the example system shown in FIG. 1, analog to digital conversion. Analog to digital conversion of a received signal allows more complex communication functions such as demodulation and decoding to be performed in the DSP 20. In a similar manner, signals to be transmitted are processed, including modulation and encoding for example, by the DSP 20 and input to the transmitter 14 for digital to analog conversion, frequency up conversion, filtering, amplification and transmission over the communication network 19 via the antenna 18.

The DSP 20 not only processes communication signals, but also provides for receiver and transmitter control. For example, the gains applied to communication signals in the receiver 12 and transmitter 14 may be adaptively controlled through automatic gain control algorithms implemented in the DSP 20.

The device 10 preferably includes a microprocessor 38 that controls the overall operation of the device. Communication functions, including at least data and voice communications, are performed through the communication subsystem 11. The microprocessor 38 also interacts with further device subsystems such as the display 22, flash memory 24, random access memory (RAM) 26, auxiliary input/output (I/O) subsystems 28, serial port 30, digital keyboard 32, speaker 34, microphone 36, a short-range communications subsystem 40, thumb input devices 50, 52 (through thumb input device control logic 54) and any other device subsystems generally designated as 42.

Some of the subsystems shown in FIG. 1 perform communication-related functions, whereas other subsystems may provide “resident” or on-device functions. Notably, some subsystems, such as digital keyboard 32, thumb input devices 50, 52 and display 22 for example, may be used for both communication-related functions, such as entering a text message for transmission over a communication network, and device-resident functions such as a calculator or task list.

Operating system software used by the microprocessor 38 is preferably stored in a persistent store such as flash memory 24, which may instead be a read only memory (ROM) or similar storage element. Those skilled in the art will appreciate that the operating system, specific device applications, or parts thereof, may be temporarily loaded into a volatile store such as RAM 26. It is contemplated that received communication signals may also be stored to RAM 26.

The microprocessor 38, in addition to its operating system functions, preferably enables execution of software applications on the device. A predetermined set of applications which control basic device operations, including at least data and voice communication applications for example, will normally be installed on the device 10 during manufacture. Further applications may also be loaded onto the device 10 through the network 19, an auxiliary I/O subsystem 28, serial port 30, short-range communications subsystem 40 or any other suitable subsystem 42, and installed by a user in the RAM 26 or preferably a non-volatile store (not shown) for execution by the microprocessor 38. Such flexibility in application installation increases the functionality of the device and may provide enhanced on-device functions, communication-related functions, or both. For example, secure communication applications may enable electronic commerce functions and other such financial transactions to be performed using the device 10.

In a data communication mode, a received signal such as a text message or web page download will be processed by the communication subsystem 11 and input to the microprocessor 38, which will preferably further process the received signal for output to the display 22, or alternatively to an auxiliary I/O device 28. A user of device 10 may also compose data items such as email messages for example, using the keyboard 32, and thumb input devices 50, 52 in conjunction with the display 22 and possibly an auxiliary I/O device 28. Such composed items may then be transmitted over a communication network through the communication subsystem 11.

The serial port 30 in FIG. 1 would normally be implemented in a personal digital assistant (PDA)-type communication device for which synchronization with a user's desktop computer (not shown) may be desirable, but is an optional device component. Such a port 30 would enable a user to set preferences through an external device or software application and would extend the capabilities of the device by providing for information or software downloads to the device 10 other than through a wireless communication network. The alternate download path may for example be used to load an encryption key onto the device through a direct and thus reliable and trusted connection to thereby enable secure device communication.

A short-range communications subsystem 40 is a further optional component which may provide for communication between the device 24 and different systems or devices, which need not necessarily be similar devices. For example, the subsystem 40 may include an infrared device and associated circuits and components or a Bluetooth™ communication module to provide for communication with similarly enabled systems and devices.

Thus, it will be apparent that handheld devices of this type perform a wide variety of complex functions and it is a challenge to provide a keyboard which is sufficiently compact to match the form factor of the handheld device but which provides the necessary level of functionality required by the user

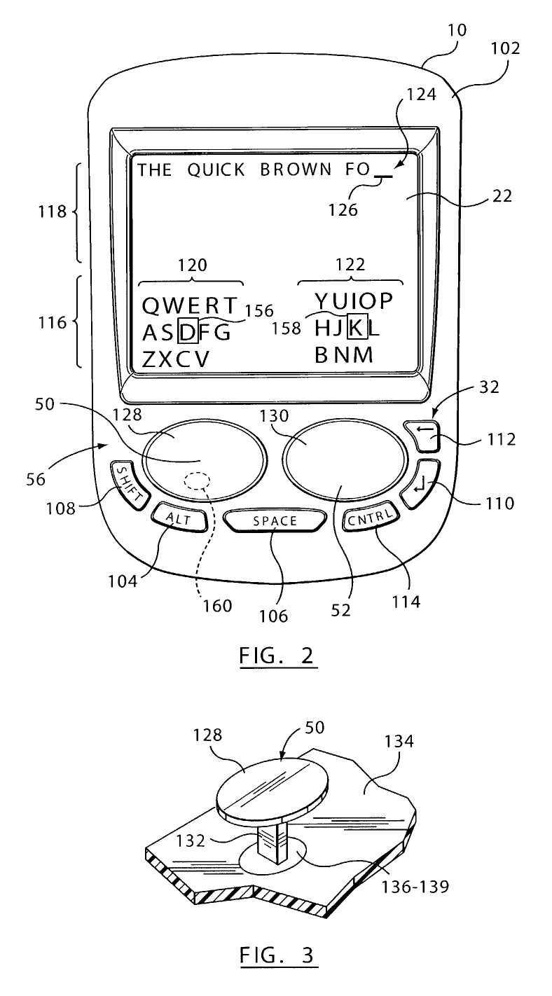

FIG. 2 is a plan view of a handheld device 10 according to an embodiment of the present invention. The device 10 has a case 102 housing the subsystems of FIG. 1, including a thumb-actuated keyboard 56 that includes adjacent right and left thumb input devices 50, 52, which, as will be described in greater detail below, are used to provide alphanumeric input to the device 10. The thumb-actuated keyboard 56 also includes a digital keyboard 32 that includes a SPACE key 106, and various control and function non-alphanumeric keys typically found on a keyboard such as a SHIFT key 108, an ALT key 104, a CNTRL key 114, a RETURN key 110, and a BACKSPACE key 112. The keys of the digital keyboard 32 are each used to actuate corresponding digital keyboard switches provided on a printed circuit board of the device 10. The handheld device 10 is configured such that a user can hold the device with both hands and input data using his or her left and right thumbs to manipulate the left and right thumb input devices 50, 52, respectively, and also activate the keys of digital keyboard 32. In one embodiment, the keys of digital keyboard 32 are arranged in a U-shaped configuration around left and right thumb input devices 50, 52. The display screen 22, which may be a full graphic LCD or other suitable display, is located above the thumb-actuated keyboard 56 such that the screen 22 can be viewed without physical interference from the user's hands. It will be appreciated that other interference free configurations could also be used.

The right and left thumb input devices 50 and 52 can each be used to selectively input symbols from a set of predetermined symbols. In the embodiment shown in FIG. 2, the symbols are alphanumeric characters that are laid out in standard QWERTY format, although the present invention is not limited to such a format or to alphanumeric characters. The left thumb input device 50 can be used to select and input the 14 characters of the alphabet that are normally typed with a left hand on a conventional full size QWERTY keyboard, and the right thumb input device 52 can be used to input the 12 characters of the alphabet that are normally typed with a right hand. When the keyboard 56 is in use, the screen 22 is electronically divided into upper and lower portions 118, 116, with upper portion 118 functioning as a conventional screen displaying in a conventional manner the current working alphanumeric text 124 that the user is viewing or editing, with a cursor 126 providing a visual indication of the current editing position within the displayed text. The lower screen portion 116 is used to provide visual feedback to the user of a pending character selection and in this regard displays a virtual keyboard showing the possible characters that can be selected by the input devices 50, 52. Preferably, the lower display screen portion 116 is further divided into left and right screen portions 120, 122, with the lower left screen portion 120 displaying the characters that are selectable as input by the left input device 50, and the lower right screen portion 122 displaying the characters that are selectable as input by the right input device 52.

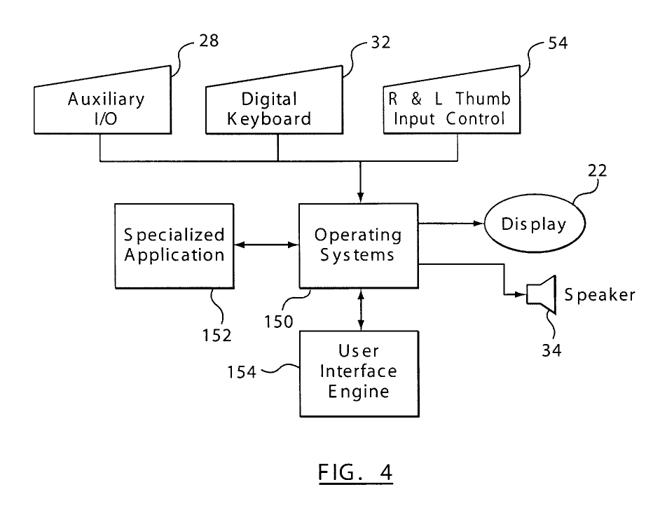

In one preferred embodiment, the left and right input devices 50, 52 are analog “joystick” type devices each including an oval, concave paddle 128, 130, that is ergonomically designed to be comfortably manipulated by thumbs of varying sizes and shapes. Each of the paddles are preferably located close enough to a respective side edge of the device 10 such that the user's fingers can support the back of the device with the user's left and right thumbs wrapping around to the front of the device to engage the left and right paddles 128, 130 respectively. The thumb input devices 50, 52, are each sensitive to forces in the X and Y directions (i.e. parallel to the plane of the keyboard 56), and in the Z direction. The analog thumb input devices 50, 52 can take many different configurations known in the art for multi-dimensional analog input devices, and in this regard one possible configuration for thumb input device 50 is shown in more detail in FIG. 3. The thumb input device 50 includes a ceramic or plastic shaft 132 embedded in the circuit board 134 of the handheld device 10 at one end, with the paddle 128 fixed to the other end of the shaft. The shaft 132 has four thick-film strain gauges 136-139 silk-screened on its sides. Forces on the paddle result in bending or compression of the shaft 132 and consequent elongation or compression of the strain gauges bonded to the sides of the shaft 132 near the base of the thumb input device 50. The connection between the shaft 132 and the circuit board physically biases the thumb input device 50 into a normal resting or “home” position when no force is being applied to paddle 128. Right thumb input device 52 is substantially identical to left thumb input device 50. The paddles 128 and 130 may be covered by a resilient web—as will be appreciated by those skilled in the art, the keys of keyboards used in portable devices often include a plurality of independent pliable keys formed in a single web component.

The analog signals from the strain gauges 136-139 of the right and left thumb input devices 50, 52 are representative of the magnitude of pressure applied to the paddles 128 and 130 and the direction of such pressure. The signals are provided to right and left thumb input device logic control 54 for conversion to digital signals for input to microprocessor 38. As noted above, in one preferred embodiment, the left thumb input device 50 is used to input 14 different characters from the left half of the conventional QWERTY keyboard layout, and the right thumb input device 52 is used to input the other 12 characters, and accordingly, the control logic 54 is configured to generate digital signals indicative of at least 13 different physical positions of left paddle 128 relative to its normally biased position, and similarly, the control logic 54 is configured to generate digital signals indicative of at least 11 different physical positions of right paddle 130. Other input devices using analog sensing means other than or in addition to strain gauges could alternatively, be used, including for example, piezo-electric or piezo-resistive sensors, magnetic reluctance sensors, optical sensors, variable inductance sensors, thermal sensors, and combinations of the forgoing. Analog input devices and their associated control logic are known in the art (for example, the IBM TrackPoint™ family of devices) and accordingly will not be described in greater detail. The non-alphanumeric keys 104, 106, 108, 110, 114 and 112 of the digital keyboard 32 portion of thumb input keyboard 56 are conventional discrete binary switches.

FIG. 4 shows some of the systems implemented by software running on microprocessor 38 includes the operating system 150, and various specialized applications 152, one of which is a user interface engine 154. The operating system 150 coordinates operation of the specialized applications and communications with the various I/O systems such as the right and left thumb input control logic 54, digital keyboard 32, display 22, speaker 34 and auxiliary I/O 28. In one embodiment, the operating system 150 passes information received from the digital keyboard and right and left thumb input control logic 54 to the user interface engine 154, and receives control information from the user interface engine 154 for display 22 and speaker 34. The user interface engine receives X, Y, and Z coordinate data in respect of the right and left thumb paddles 128, 130 and processes the information according to standard algorithms to map specific X, Y and Z data to a particular character as displayed in screen portions 120, 122.

Turning again to FIG. 2, the characters displayed in lower left and right screen portions 120 and 122 are each arranged in two dimensional arrays such that the characters have a physical location that corresponds to a physical location of each of the paddles 128, 130, and a user can select a particular character by applying a corresponding thumb pressure. In the QWERTY arrangement of FIG. 2, the letter “D” is associated with the normal or home position of left thumb paddle 128, and the letter “K” is associated with the home position of right thumb paddle 52. In order to provide the user with a visual feedback of pressure applied to the location of thumb paddles 128, 130, the user interface engine 154 is configured to cause the operating system to visually highlight in each of the screen portions 120, 122, the character that corresponds to the current position of the respective left and right paddles 128, 130. Such highlighting could take many different forms, and is represented by boxes 156, 158 in FIG. 2, in which the characters “D” and “K” are highlighted, indicating that the paddles 128 and 130 are shown in their normal home positions.

In order to select or highlight a character for input, a user applies physical pressure to the respective paddles 128, 130 in a location or direction that corresponds to the physical location of the desired character in the respective screen portions 120, 122. For example, in order to select an “X”, the user may apply pressure to the left thumb paddle 128 at the spot marked by phantom circle 160, which is below and to the left of the center of the paddle 128. In response to such pressure, the microprocessor 38 will move on-screen highlight box 156 from character “D” to character “X” to provide a visual indication that the current pressure location on the paddle 128 corresponds to “X”. In one embodiment, a click or other audible signal is generated by the speaker 34 when an new character is highlighted to provide an aural indication that the microprocessor 38 has locked onto a new character selection. When selecting different characters, a user will typically not actually physically move their thumbs to physically press on the portion of the paddle that corresponds to the character, but rather may just shift the pressure applied by their thumbs in the appropriate direction. For example, when selecting the character “X”, the user's thumb may be positioned in the center of the paddle 128 rather than right on spot 160, but the user will be apply sideways pressure on the center of the paddle in the direction of the spot 160, causing similar forces to be applied to strain gauges 136-139 as if spot 160 had been pressed directly. The strain gauges 136-139 generate signals that are indicative of the magnitude and direction of the force being applied to respective paddles relative to a normal resting state. Actual physical movement of the paddles 128, 130 may be minute and may be imperceptible to the user.

As can be appreciated from FIG. 2, if the target character is an outer character such as “T”, when physical pressure is applied to the portion of paddle 128 corresponding to the letter “T”, the paddle 128 may pass through physical positions corresponding to one or more other characters such as “F” and “R” prior to getting to the position that corresponds to the “T”. On some embodiments, the highlight box 156 may momentarily highlight the intermediate characters in screen portion 116 and sound an audible click for each character passed while moving to the “T”. In other embodiments, the microprocessor could be configured to suppress the highlight box and audible click while the paddle is, according to predetermined thresholds, in a transitory state, thereby causing the highlight box 156 to generally skip over intermediate characters.

In order to avoid erroneous input, momentary application of pressure on the location of a paddle 128, 130 that corresponds to a particular character will generally not be sufficient to cause the selected character to be actually registered as an inputted character. Rather, further action on the part of the user will generally be required to cause a selected character to actually be inputted into the working text buffer maintained by microprocessor 38 and displayed in upper screen display portion 118. In one embodiment, this further action may simply be to continue to apply pressure to the corresponding paddle location for a predetermined time period (In the case of home characters “D” and “K”, pressure in the Z axis would be required). In another embodiment, a character selected using one of the paddles can be input by simultaneously pressing a selected one of the digital keys, for example the CONTROL key 114, while the character is highlighted. Alternatively, the further action may be to, while one paddle is used to select the character, apply a predetermined pressure in the Z axis direction on the other paddle to signal input. In yet another embodiment, applying a predetermined pressure in the Z axis direction to the same paddle 128, 130 used to select the character may also be used to signal acceptance by the user of the highlighted character as input. In some embodiments, the joystick shafts 132 of the input devices 50, 52 may be mounted to respective binary push switches rather than embedded into the circuit board so that predetermined pressure in the Z direction results in activation of the binary switch, the activation of such switch signalling that a selected character should be inputted. Once a highlighted character has been selected as input, it is added to the text of working text screen portion 118, and the highlight box in the display portion 120, 122 from which the character was selected returns to its home position. Preferably the highlight box will return momentarily to its home position even if the corresponding thumb input paddle is biased away from its home position, and then move to the position that corresponds to the pressure on such thumb input paddle.

As with conventional keypads, the SHIFT key 108 can be used to create upper case letters. In some embodiments, pressing the SHIFT key at the same time that the user actually performs the action necessary to input a selected character will result in an upper case letter. In some embodiments, pressing the shift key may toggle between different screen display modes, with lower case being the default characters in one mode and upper case being the default in the other mode.

The paddles 128, 130 could include physical markings (not shown) on their respective surfaces showing the corresponding locations to press for corresponding characters, however, the paddles will typically be covered by the user's thumbs with the user relying principally on the on-screen display in screen portions 120, 122 for a visual indication of what characters they are selecting. The use of an electronic display of selectable symbols combined with analog input devices that are physically mapped to the displayed symbols provides a versatile and easily configurable user input system. In a preferred embodiment, the microprocessor 38 is configured to selectively toggle between a plurality of different symbol sets for display in lower screen portion 116, with the mapping of paddles 128, 130 changing appropriately for each of the symbol sets. For example, the display could toggle from a QWERTY layout as shown to a Dvorak layout. Toggling may be effected by the user pressing one of the digital keys, for example the ALT key 114, or by the user actuating an auxiliary input device 28 such as a thumbwheel (not shown).

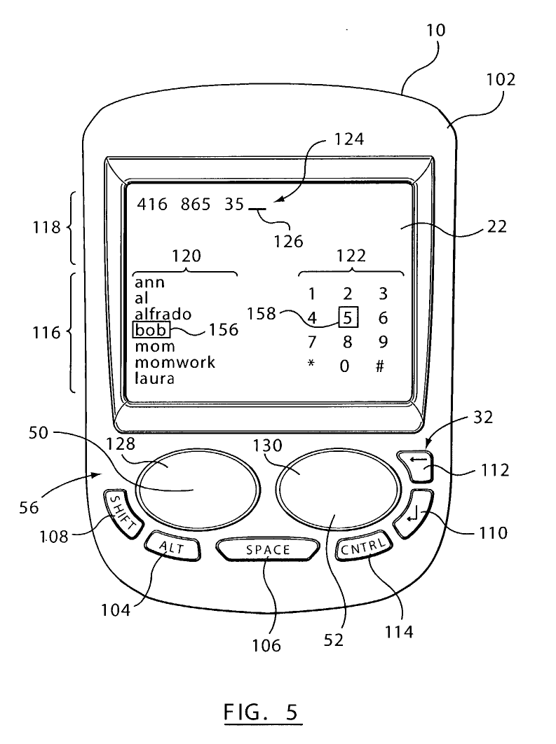

By way of example, FIG. 5 shows the hand held device 10 with further selectable symbol sets shown in the lower screen display portions 120 and 122. In particular, right display 122 shows a numeric keypad as the symbol set selectable by manipulation of the right thumb input device 52. The left display 120 shows a symbol set in which a scrollable list of names from an electronic address book are displayed as the selectable symbols for the left thumb input device 50. The configuration of FIG. 5 allows a user to input a phone number using the paddle 130 of right thumb input device 52. Although a double paddle input device is shown in FIG. 5, it will be appreciated that a hand held device, such as a wireless phone device, could be configured with a single thumb paddle to select numbers from an on-screen display. Such a device may resemble the right half of device 10 shown in FIG. 5, and would use a thumb paddle input device with on-screen feedback in place of a traditional multi-key numeric key pad.

In addition to Roman alphabetic and Arabic numeral symbol sets, selectable symbol sets for the characters and numeric symbols of other languages such as Chinese and Japanese could be used.

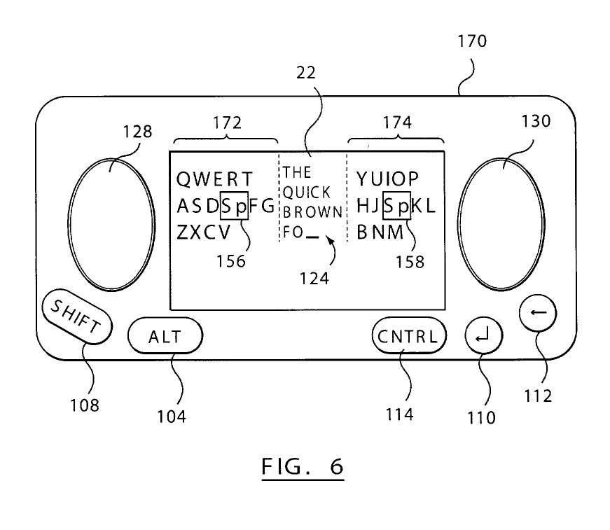

It will be appreciated that the handheld device of the present invention could have a number of different physical layouts other than as shown in FIGS. 2 and 5. By way of example, FIG. 6 shows a further embodiment of a mobile communications device 170 that is substantially identical to mobile communications 10 except for the differences that will be apparent from the Figures and the following description. In device 170, the screen 22 is centrally located between the left thumb paddle 128, and right thumb paddle 130. The character set selectable by the left thumb paddle 128 is displayed at a left side portion 172 of display screen 22, and the character set selectable by the right thumb paddle 130 is displayed at a right side portion 174 of display screen 22, with a centrally located display area to display the current working text 124. In communications device 170, the traditional QWERTY layout has been modified to include the “SPACE” character (identified as “Sp” in FIG. 6) in the virtual keyboard at positions corresponding to the normal resting positions of each of the paddles 128 and 130, as highlighted by highlight boxes 156, 158. In device 170, the axes of elliptical paddles 128 and 130 are rotated 90 degrees relative to their orientation in device 10.

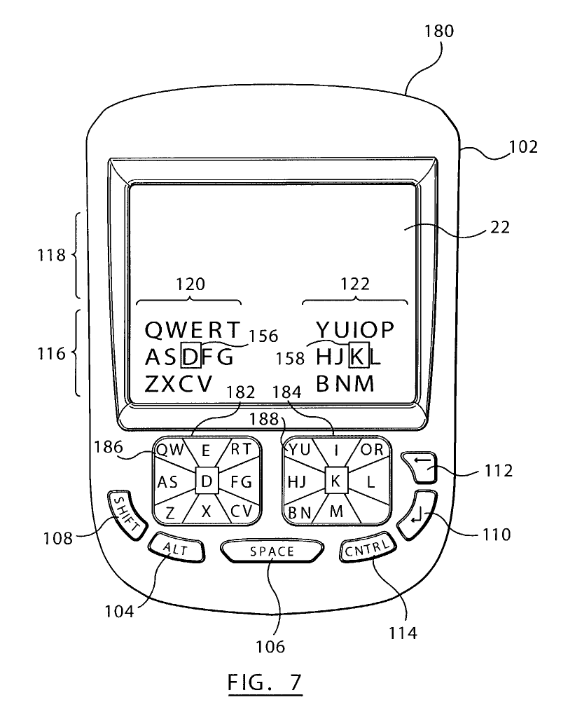

In place of paddles 128 and 130, different analog input devices could alternatively be used, for example touch pad type devices could be appropriate in some applications. In some embodiments, analog thumb input devices 50, 52 could be replaced with multi-way digital switches. By way of example, FIG. 7 shows a further mobile communications device 180 according to another embodiment of the invention that is substantially identical to device 10 with the exception of differences that will be apparent from the Figures and the following description. In communications device 180, eight-way digital switch thumb actuated input devices 182 and 184 are used in place of the analog input devices 50, 52 of device 10. The multi-switch digital devices 182, 184 could take a number of different configurations, and would not require analog to digital conversion control logic 54 as required by the analog input devices 50, 52 of device 10. In one possible embodiment, the digital devices 182 and 184 each have a paddle style joystick configuration similar to that shown in FIG. 3, with strain gauges 136-139 being replaced with eight discrete binary micro-switches responsive to minute movements of the shaft 132. Alternatively, eight discrete binary switches fixed to the circuit board could be positioned under corresponding inner protrusions formed on each of the paddles 186, 188, respectively, of right and left input devices 182 and 184.

As shown in FIG. 7, the paddles 186, 188 of right and left input devices 182 and 184 are each divided into 8 octant areas surrounding a central area. Each of the eight perimeter paddle areas correspond to one of the binary switches, which are mapped by user interface engine 154 to specific characters shown in the display areas 120 and 122. As can be appreciated, eight discrete switches or eight-way switches are used in each of the input devices 182 and 184 to input 14 and 12 characters respectively, and accordingly, some of the octant areas are mapped to and represent more than one character on the display screen. By way of example, the octant and central areas of paddles 186 and 188 of FIG. 7 are each marked with the character or characters to which they are mapped (such paddle markings are not required for operation of the invention as the paddles will typically be obscured from view by the user's thumbs).

As with analog input devices 50, 52, the digital input devices 186, 188 each are biased to a neutral or normal resting position that corresponds to the central area of the paddles 186, 188, which are respectively marked by the characters “D” and “K”. Left and right highlight boxes 156 and 158 are moved among the characters shown in display portions 120, 122, in response to pressure applied to left and right paddles, respectively, to provide the user with visual feedback of the character being selected by the user for pending input. In one embodiment, once a user has manipulated one of the paddles to highlight a desired character in screen portion 120 or 122, the user performs a further action such as pressing CONTROL key 114 to select the highlighted character as input, after which the inputted character is added to the working text buffer maintained by microprocessor 38 and displayed in upper screen area 118 in a conventional manner.

The handheld device 180 preferably uses some predictive text software application in order to deduce what character the user is attempting to highlight. For example, if the user were to apply pressure to the left thumb paddle 186 in the octant area labelled “QW”, the software would determine whether the user intends to enter a “Q” or a “W”, and highlight the appropriate selection with highlight box 156 on screen portion 120. This may be initiated, for example, by appropriate inputs from the user through further keyboard or auxiliary inputs. Predictive text routines are known in the art. Such predictive text applications tend to become more accurate and thus more useful with subsequent keystrokes, as the “root” term upon which a prediction is based increases in length. As such, it is contemplated that the predictive text application may be activated after a certain number of characters have been inputted, such that a root term has a predetermined minimum length. Until that point is reached, the initial characters in the minimum length root term may be manually highlighted on screen portions 120, 122 in various ways, for example by depressing the corresponding area of the corresponding paddle multiple times, or by operating a further key or input while applying pressure to a selected octant area of the paddle. Predictive text routines are typically executed by a keystroke interpreter that receives user input signals from the operating system. With reference to FIG. 4, the keystroke interpreter may be part of the user interface engine 154, or a separate specialized application 152. It will be appreciated that predictive text routines could also be used with the handheld mobile communications device 10.

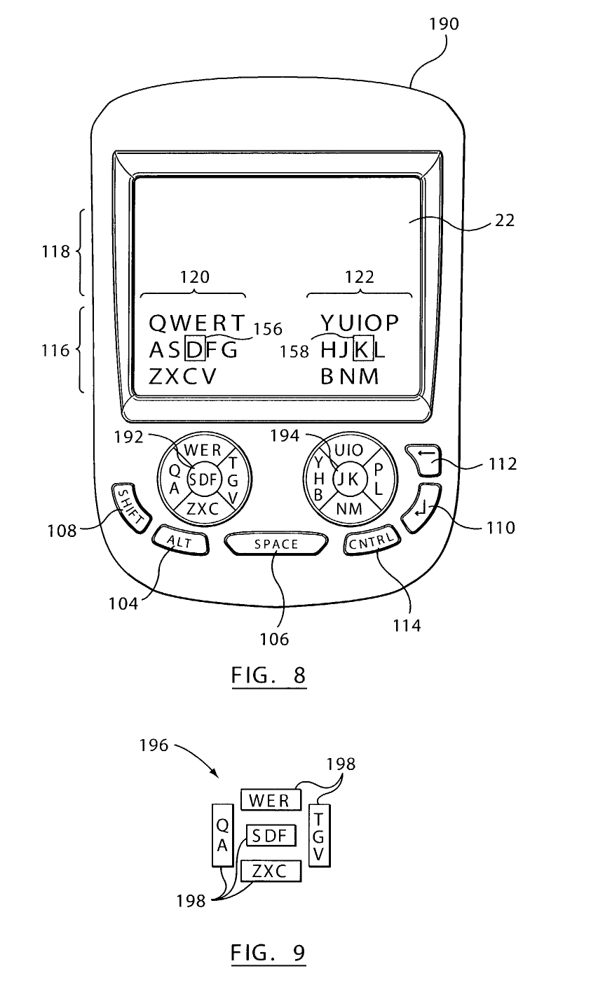

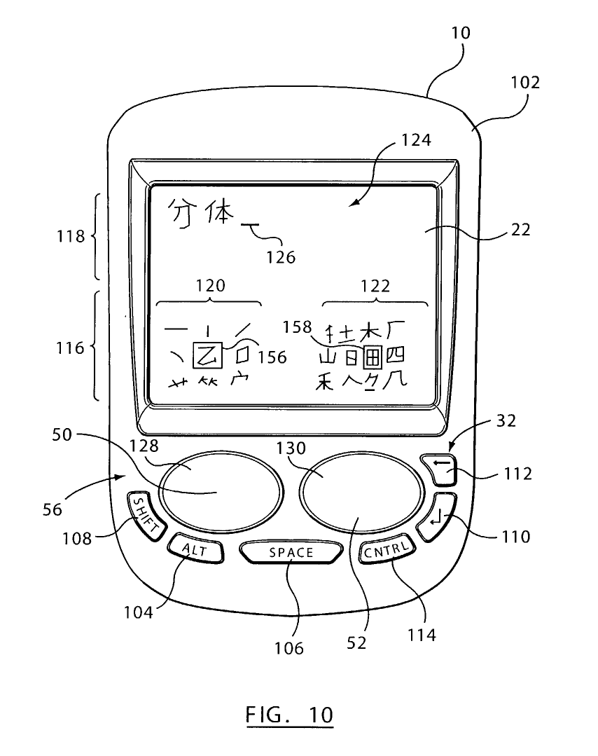

In some embodiments of the invention, right and left digital thumb input devices 182, 184 could be replaced with multi-switch devices having more or less than eight switches, and in this regard, FIG. 8 shows an embodiment of a mobile communications device 190 that is substantially identical to device 180 except that 5 way switch devices 192 and 194 are used as left and right and thumb inputs, rather than the 8-way switches 182, 184, with correspondingly more characters being mapped to each of the switches. In this regard the right and left thumb input devices 192, 194 are each divided into four quadrants, each corresponding to a binary switch, that surround a central area, which itself corresponds to a switch activated pushing directly in on the paddle of the input device. In the embodiments of FIGS. 7 and 8, the right and left thumb multi-switch input devices have been shown as each including a single paddle style key for actuating each of the switches included in the respective devices. However, in some embodiments, the right and left thumb input devices could each include a plurality discrete push keys, and in this regard, FIG. 9 shows a further left thumb 5-switch input device 198 comprising a plurality of 5 discrete keys 198 that are arranged to be actuated by a left thumb. Although the keys 198 may be physically separated externally, as is known in the art, they could be connected under the case of the handheld device 190 to a common web in which they are formed.

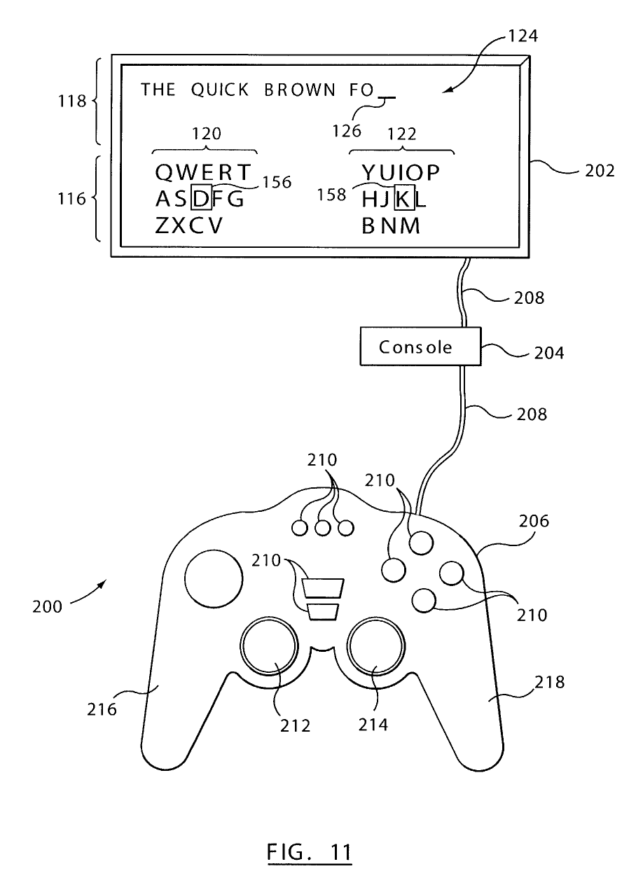

As suggested above, non-Roman alphabet characters could be mapped to the right and left thumb input devices of the present invention so that the hand held device could conveniently be configured for use by speakers of many different languages. By way of example, FIG. 10 shows the hand held device 10 displaying further sets of selectable symbols in lower screen portions 120 and 122 that are mapped to specific pressure points on the paddles 128 and 130. The selectable symbols in FIG. 10 can be used to input Chinese characters or Japanese kanji using a stroke input technique. The use of stoke inputs for inputting Chinese characters is generally known in the art—for example, Q9Tech™ offers a stroke based input system based on a conventional telephone key-pad.

In FIG. 10, the selectable character set displayed in left display portion 20 includes nine different selectable sub-characters or “strokes” that can be used to build a character. The strokes can be highlighted by applying pressure on the left paddle 128 that corresponds to the relative on-screen locations of the strokes, and a highlighted stroke inputted by one of the input techniques noted above. In the right screen portion 122 a number of selectable Chinese characters are displayed. In particular, a predictive character application running as a specialized application 152 on the microprocessor 38 of device 10 predicts, based on previous stroke inputs, the most likely characters that the user is attempting to input, and displays the characters in right screen portion 122. Thus, the characters displayed in right screen portion 122 may change with each stroke input from left screen portion 120. Once the user has inputted, using left paddle 128, sufficient strokes so that the desired character is displayed as one of the twelve characters in right screen portion 122, the user can highlight the desired character by applying pressure to the right paddle 130 corresponding to the physical on-screen location of the desired character. Once highlighted, the character can be inputted using any of the techniques described above, after which it will be displayed in working text area 124 of screen 22. The predictive character application may consider previously inputted characters as well as previously inputted strokes when determining what selectable characters should be displayed in right display screen portion 122.

Although the present invention has heretofore been described in the context of a portable electronic device, embodiments of the present invention could also be applied to electronic devices that are not intended to be portable when in use. By way of example, FIG. 11 shows a system 200 according to a further embodiment of the present invention. The system 200 includes the physical components of a conventional home video gaming system, namely a central console unit 204 that houses the majority of the electronic components of the gaming system, a display screen 202 (which is typically a conventional TV), and at least one handheld controller 206. The console 204 is connected by wires 208 or by wireless links to the display screen 202 and hand held controller. The consol unit 204 may house most of the subsystems shown in FIG. 1, with the exception of aspects of the input related subsystems that implemented by the hand-held controller 206 and aspects of the audio and visual display related subsystems that are implemented by display screen 202. The system 200 may or may not include a communications subsystem 11, and if included the subsystem 11 may not be wireless enabled but rather may be configured to communicate over high-speed wire connection such as Internet cable or DSL (digital subscriber line).

According to the present invention, a software application running on the microprocessor of the console 204 can allow the handheld controller 206 to be used as a text entry device. Such a feature is useful if the system 200 is Internet enabled and there is a desire to use the controller 206 for text entry rather than require an auxiliary keyboard. Handheld controller 206 includes a number of binary input keys 210, as well as thumb actuated left and right analog paddle style joysticks 212 and 214, which can be used to control on-screen navigation of various elements when the system is used for game playing. Left and right joysticks 212 and 214 are positioned near respective left and right handles 216 and 218. Text entry using system 200 is substantially similar to that of device 10 described above. Namely, the left analog joystick 212 is used to navigate among and highlight selectable characters displayed in lower left screen portion 120, and the right analog joystick 214 is used to navigate among and highlight selectable characters displayed on lower right screen portion 122. Highlighted characters can then be inputted by a further user action, such as simultaneously pressing a selected one of the binary keys 210, after which the inputted character will be added to working text display area 124 of display screen 202. Thus, the paddles 212 and 214 of controller 206 can be used not only to navigate during conventional game playing on the system 200, but can also be used for text entry.

The above-described embodiments of the present invention are intended to be examples only. Alterations, modifications and variations may be effected to the particular embodiments by those skilled in the art without departing from the scope of the invention, which is defined by the claims appended hereto.

We claim:

1. An electronic device comprising:
an electronic display screen having a first display area for displaying a first set of a plurality of selectable symbols and a second display area for displaying a second set of a plurality of selectable symbols;
a first user input device for selecting symbols from the first set, the first user input device generating a first selection signal in response to force applied thereto;
a second user input device for selecting symbols from the second set, the second user input device generating a second selection signal in response to force applied thereto; and
a processor connected to the display screen and the first and second input devices for causing a selected symbol in the first set to be visually highlighted in the first display area in response to the first selection signal and a selected symbol in the second set to be visually highlighted in the second display area in response to the second selection signal.

2. The device of claim 1 wherein the first user input device and the second user input device each sense in at least two dimensions a direction of a force applied thereto and said first selection signal and said second selection signal each include corresponding directional force information.

3. The device of claim 2 wherein each of the symbols in the first set and each of the symbols in the second set are displayed in predetermined display locations in the first and second display areas respectively, the processor associating each of the symbols in the first set to directional force information from the first input device and the symbols in the second set to directional force information from the second input device.

4. The device of claim 3 wherein the processor associates each of the symbols in the first set with unique directional force information from the first input device that corresponds to the relative display locations of the symbols in the first set, and the processor associates each of the symbols in the second set with unique directional force information from the second input device that corresponds to the relative display locations in the second set.

5. The device of claim 4 wherein the first set includes the alphabetic characters associated with left hand typing in a conventional QWERTY layout and the second set includes the alphabetic characters associated with right hand typing in a conventional QWERTY layout.

6. The device of claim 1 wherein the display screen includes a further display area for inputted symbols, the processor configured to display a symbol highlighted in either the first or second display areas in the further display area as an inputted symbol upon receiving a predetermined user input to input the symbol.

7. The device of claim 6 wherein the predetermined user input for inputting a symbol highlighted in the first display area includes a force having predetermined characteristics applied to the second user input device and the predetermined user input for inputting a symbol highlighted in the second display area includes a force having predetermined characteristics applied to the first user input device.

8. The device of claim 6 wherein the predetermined user input for inputting a symbol highlighted in the first display area includes a force having predetermined characteristics applied to the first user input device and the predetermined user input for inputting a symbol highlighted in the second display area includes a force having predetermined characteristics applied to the second user input device.

9. The device of claim 6 further including a further user input device operatively connected to the processor for providing the predetermined user input for inputting a symbol highlighted in either the first or second display areas.

10. The device of claim 1 wherein the first user input device includes a first thumb actuated physical interface and a first sensing device for sensing in a plurality of directions lateral force applied to the first thumb actuated physical interface, said first selection signal including directional information of a sensed lateral force applied to the first physical interface, and the second user input device includes a second thumb actuated physical interface and a second sensing device for sensing in a plurality of directions lateral force applied to the second thumb actuated physical interface, said second selection signal including directional information of a sensed lateral force applied to the second physical interface.

11. The device of claim 10 wherein the first and second sensing devices each include analog sensing means for sensing analog characteristics of forces applied to the first and second physical interfaces respectively, the device including control logic for converting the sensed analog characteristics to the first and second selection signals.

12. The device of claim 11 wherein the first and second thumb actuated physical interfaces each include a paddle, the analog sensing means including strain gauges arranged to sense forces applied to the paddles.

13. The device of claim 10 wherein the first and second sensing devices each include a plurality of discrete binary switches activated by physical manipulation of the first and second physical interfaces.

14. The device of claim 10 wherein the first set includes the alphabetic characters associated with left hand typing in a conventional QWERTY layout and the second set includes the alphabetic characters associated with right hand typing in a conventional QWERTY layout.

15. The device of claim 14 wherein the first and second thumb actuated physical interfaces are each biased to a home position when no forces above predetermined thresholds are applied thereto, the directional information in the first and second selection signals being relative to the home positions of the first and second thumb actuated physical interfaces, respectively.

16. The device of claim 15 wherein the alphabetic characters in the first and second display areas are each arranged in predetermined two dimensional arrays, the processor causing a predetermined centrally located symbol in the array of first display area to be visually highlighted when the first thumb actuated device is in its home position, and a predetermined centrally located symbol in the array of the second display area to be visually highlighted when the second thumb actuated device is in its home position, the processor highlighting characters in the first and second display areas corresponding to directional forces applied to the first and second thumb actuated devices relative to the home positions thereof.

17. The device of claim 16 wherein the predetermined centrally located symbol in at least one of the first and second display areas is a symbol that corresponds to a “space” character.

18. The device of claim 1 wherein a common selection signal from the first user input device is associated with a plurality of possible symbols from the first set, and a common selection signal from the second user input device is associated with a plurality of possible symbols from the second set, the processor having a predictive application associated therewith for predicting, based on previously highlighted symbols, which symbol to highlight from the plurality of possible symbols in the first and second sets, respectively, in response to the common selection signals.

19. The device of claim 1 wherein the processor is configured to change the selectable symbols displayed in the first and second sets in response to a user instruction.

20. The device of claim 1 wherein the first set and the second set of symbols each include a plurality of alphabetic characters, and the first user input device and second user input device each include a plurality of discrete binary switches each corresponding to a plurality of alphabetic characters for providing input signals, the processor having an associated keystroke interpreter for receiving the input signals from the plurality of discrete binary switches and employing a predictive text routine for mapping the received inputs to alphabetic characters for highlighting as selected symbols in the first and second display areas.

21. The device of claim 1 wherein the device is a portable device including a case having a front and back joined by peripheral sides; the display screen, first and second user input devices and processor being housed in the case with the display screen display areas being visible at the front of the case; the first and second user input devices each having thumb actuatable portions present on the front of the case; the device having dimensions permitting a user to support the back of the device with fingers of the user's left and right hands simultaneously while the user's left and right thumbs manipulate the thumb actuatable portions of the first and second user input devices respectively.

22. The device of claim 1 wherein the first and second user input devices are housed in a handheld controller that is remotely located from the microprocessor.

23. The device of claim 1 wherein the microprocessor is configured to accept a highlighted symbol as an inputted symbol upon receiving a predetermined user input, the second set of selectable symbols displayed in the second display area being determined by the microprocessor based on symbols inputted from the first set.

24. The device of claim 23 wherein at least some of the symbols in the first set are sub-components of at least some of the symbols in the second set.

25. A method of selecting characters for input to an electronic device, comprising the steps of:
(a) displaying on an electronic display screen a first set of selectable characters in a first area of the display screen;
(b) displaying on the electronic display screen a second set of selectable characters in a second area of the display screen;
(c) visually highlighting in the first area a selected character in the first set when a directional signal is received from a first input device that corresponds to a physical display location of the selected character; and
(d) visually highlighting in the second area a selected character in the second set when a directional signal is received from a second input device that corresponds to a physical display location of the selected character in the second set.

26. The method of claim 25 further including a step of:
(e) accepting a visually highlighted character as an inputted character when a predetermined user input is received and displaying the inputted character in a third area of the display screen.

27. The method of claim 26 including using a first thumb to manipulate the first input device to provide the directional signal therefrom and using a second thumb to manipulate the second input device to provide the directional signal therefrom.

28. The method of claim 26 wherein the first set includes the alphabetic characters associated with left hand typing in a conventional QWERTY layout and the second set includes the alphabetic characters associated with right hand typing in a conventional QWERTY layout.

29. A computer program product comprising a computer readable medium carrying program code means for selecting characters for input to an electronic device, the program code means including means for:
(a) displaying on an electronic display screen a first set of selectable characters in a first area of the display screen;
(b) displaying on the electronic display screen a second set of selectable characters in a second area of the display screen;
(c) visually highlighting in the first area a selected character in the first set when a directional signal is received from a first input device that corresponds to a physical display location of the selected character;
(d) visually highlighting in the second area a selected character in the second set when a directional signal is received from a second input device that corresponds to a physical display location of the selected character in the second set; and
(e) accepting a visually highlighted character as an inputted character when a predetermined user input is received and displaying the inputted character in a third area of the display screen.

30. An electronic device comprising:
an electronic display screen having a first selectable text display area for displaying a plurality of selectable alphabetic characters in a two dimensional array, and a working text display area for displaying characters selected as input from the characters displayed in the first selectable text display area;
a first user input device for selecting characters in the selectable text display area, the first user input device responsive to force applied thereto in a plurality of directions to generate a first selection signal that indicates a direction of a force applied thereto relative to a biased resting position of the first user input device; and
a processor operatively connected to the display screen and connected to receive first selection signals from the first user input device, for:
i) mapping the first selection signal associated with the resting position of the first user input device to a predetermined home character located in a central position in the two dimensional array of selectable characters, and mapping the first selection signal to the selectable characters around the predetermined home character based on the display locations of the selectable characters relative to the predetermined home character;
ii) signalling the display screen to visually highlight in the first selectable text area a selected character in response to the first selection signal according to the mapping; and
iii) signalling the display screen to display a selected character in the working text display area as an input character upon receiving a further user input when the selected character is visually highlighted in the first selectable text area.

31. The device of claim 30 wherein the display screen includes a second selectable text display area for displaying a further plurality of selectable alphabetic characters in a further two dimensional array, the device including a second user input device for selecting characters in the second selectable text display area, the second user input device responsive to force applied thereto in a plurality of directions to generate a second selection signal that indicates a direction of a force applied thereto relative to a biased resting position thereof; the processor connected to receive the second selection signal from the second user input device, for:
i) mapping the second selection signal associated with the resting position of the second user input device to a further predetermined home character located in a central position in the further two dimensional array of selectable characters and mapping the second selection signal to the selectable characters around the further predetermined home character in the further two dimensional array based on their display locations relative to the further predetermined home character;
ii) signalling the display screen to visually highlight in the further two dimensional array a selected character in response to the second selection signal according to the mapping; and
iii) signalling the display screen to display a selected character in the working text display area as an input character upon receiving a further user input when the selected character is visually highlighted in the further two dimensional array.

32. The device of claim 31 wherein first selectable text display area displays the alphabetic characters associated with left hand typing in a conventional QWERTY layout and the second selectable text display area displays the alphabetic characters associated with right hand typing is a conventional QWERTY layout.
